(19) United States
(12) Patent Application Publication
(10) Pub. No.: US 2008/0012809 A1
(43) Pub. Date: Jan. 17, 2008

(54) Display driver integrated circuits and liquid crystal displays having the same

(76) Inventors: Ki-Bum Kim, Incheon-city (KR); Jae-Goo Lee, Yongin-si (KR); Seung-Woo Lee, Yongin-si (KR)

Correspondence Address: HARNESS, DICKEY & PIERCE, P.L.C., P.O. BOX 8910, RESTON, VA, 20195, US

(21) Appl. No.: 11/826,046

(22) Filed: Jul. 11, 2007

(30) Foreign Application Priority Data
Jul. 11, 2006 (KR) 10-2006-0065042

(51) Int. Cl. G09G 3/36

(52) U.S. Cl. 345/87

(57) ABSTRACT

A liquid crystal display includes a liquid crystal panel and a display driver integrated circuit. The liquid crystal panel includes an array of pixels arranged at intersections of a plurality of gate lines and a plurality of source lines and a first gate driver. The first gate driver is connected to at least a portion of the plurality of gate lines and configured to operate at least a portion of the plurality of gate lines based on at least a portion of the plurality of clock signals. The display driver integrated circuit outputs a plurality of clock signals to the liquid crystal panel through plurality of terminals, and is configured to determine a correspondence between the plurality of clock signals and the plurality of terminals in accordance with a position at which the display driver integrated circuit is attached to the liquid crystal panel.

### PRIORITY STATEMENT

This U.S. non-provisional patent application claims priority under 35 U.S.C. § 119 to Korean Patent Application No. 10-2006-0065042 filed on Jul. 11, 2006 in the Korean Intellectual Property Office (KIPO), the entire contents of which are incorporated herein by reference.

### BACKGROUND

Information processing apparatuses may have various patterns, functions and increasing operation rates. Display units may be included in information processing apparatuses to enable users to monitor results of processing information. Flat panel display units may be used to reduce size and/or power consumption.

A conventional flat panel display unit such as a liquid crystal display (LCD) may embed a gate driver IC by way of tape carrier package (TCP) or chip-on-glass (COG), but reducing these architectures in terms of cost and/or topological design may be limited. LCD structures do not include driver ICs, for example, a plurality of shift registers with amorphous-silicon thin film transistors (a-Si TFTs) conducting operations accomplished by the conventional gate driver IC.

The plurality of shift registers employing a-Si TFTs may be formed on a liquid crystal panel. Driver control signals for controlling the shift registers may be different from those for controlling the conventional gate driver IC. Thus, a display driver IC (DDI) for converting control signals, which are output from a timing controller, into the driver control signals for the plurality of shift registers may be needed.

A conventional DDI may be connected to a liquid crystal panel in a COG, chip-on-flexible-printed-circuit (COF), or anisotropic conductive film (ACF). Because signal lines connecting a DDI with a liquid crystal panel is arranged on a two-dimensional plane, the DDI is joined or attached to a specific position of the liquid crystal panel.

A DDI may be coupled to multiple positions or portions of a liquid crystal panel in an LCD. But, joining a DDI with a liquid crystal panel without tangling signal lines interconnecting the DDI and the liquid crystal panel may be relatively difficult.

### SUMMARY

Example embodiments relate to liquid crystal display (LCD) apparatuses, for example, display driver integrated circuits (IC) and liquid crystal displays having the same.

Example embodiments are directed to LCDs capable of joining or attaching a display driver integrated circuit (DDI) to a liquid crystal panel in a plurality of positions. Example embodiments also provide DDIs capable of being joined or attached to multiple positions of a liquid crystal panel.

In at least one example embodiment, a display driver may include a display driver integrated circuit. The display driver integrated circuit may determine a correspondence between a plurality of clock signals and a plurality of terminals in accordance with a position at which the display driver integrated circuit is attached to a liquid crystal panel, and output the plurality of clock signals to the liquid crystal panel through the plurality of terminals based on the determined correspondence.

According to at least one example embodiment, a liquid crystal display may include a liquid crystal panel and a display driver. The liquid crystal panel may include a plurality of gate lines, a plurality of source lines, an array of pixels arranged at intersections of the gate and source lines, and a gate driver connected to the gate lines and operating the gate lines in response to the plurality of clock signals. The display driver may include a display driver integrated circuit. The display driver integrated circuit may determine a correspondence between a plurality of clock signals and a plurality of terminals in accordance with a position at which the display driver integrated circuit is attached to a liquid crystal panel, and output the plurality of clock signals to the liquid crystal panel through the plurality of terminals based on the determined correspondence.

According to at least one example embodiment, a liquid crystal display may include a liquid crystal panel and a display driver integrated circuit providing plurality of clock signals to the liquid crystal panel through plurality of terminals. The liquid crystal panel may include a plurality of gate lines, a plurality of source lines, an array of pixels arranged at intersections of the gate and source lines, and a gate driver connected to the gate lines and operating the gate lines in response to the plurality of clock signals. The display driver integrated circuit may determine a correspondence between the plurality of clock signals and the plurality of terminals in accordance with positions of joining with the liquid crystal panel.

According to at least some example embodiments, the display driver integrated circuit may be joined or attached to the liquid crystal panel by way of chip-on-glass. The gate driver may include plurality of gate driver units connected each to the gate lines, and may sequentially drive the gate lines in response to a vertical sync start signal. The display driver integrated circuit may include a clock generator configured to generate the plurality of clock signals, and a switching circuit for outputting the plurality of clock signals in correspondence with the plurality of terminals one by one in response to a selection signal.

In a liquid crystal display, according to at least one other example embodiment, a liquid crystal panel may include a plurality of gate lines, a plurality of source lines, an array of pixels arranged at intersections of the gate and source lines. A display driver integrated circuit may provide first through fourth clock signals to the liquid crystal panel through first through fourth terminals. A first gate driver may be connected to the gate lines of a first group and may operate the gate lines of the first group in response to the first and second clock signals. A second gate driver may be connected to the gate lines of a second group and may operate the gate lines of the second group in response to the third and fourth clock signals. The display driver integrated circuit may define the first through fourth clock signals to be output to the plurality of terminals based on positions to which the display driver integrated circuit is attached to the driver of the liquid crystal panel.

According to at least some example embodiments, the display driver integrated circuit may include a clock generator configured to generate the first through fourth clock signals, and a switching circuit configured to output the first through fourth clock signals corresponding to the first through fourth terminals one by one in response to selection signals. If the display driver integrated circuit is joined or attached on a first side of the liquid crystal panel, the switching circuit may output the first and second clock signals to the second and first terminals, respectively, and may output the third and fourth clock signals to the fourth and third terminals, respectively. If the display driver integrated circuit is joined or attached on a second side of the liquid crystal panel, the switching circuit may output the first and second clock signals to the third and fourth terminals, respectively, and may output the third and fourth clock signals to the first and second terminals, respectively.

According to at least some example embodiments, the display driver integrated circuit may provide the liquid crystal panel with plurality of source drive signals for activating the plurality of source lines, through plurality of data output terminals. If the display driver integrated circuit is joined or attached on a second side of the liquid crystal panel, the display driver integrated circuit may output plurality of source drive signals to the plurality of data output terminals in a reverse sequence. The source drive signals may activate the plurality of source lines. The first and second sides may be opposite to each other on the array of the pixels.

According to at least some example embodiments, if the display driver integrated circuit is joined or attached under a first side of the liquid crystal panel, the switching circuit may output the first and second clock signals to the fourth and third terminals, respectively, and may output the third and fourth clock signals to the second and first terminals, respectively. If the display driver integrated circuit is joined or attached under a second side of the liquid crystal panel, the switching circuit may output the first and second clock signals to the first and second terminals, respectively, and may output the third and fourth clock signals to the third and fourth terminals, respectively.

According to at least some example embodiments, if the display driver integrated circuit is joined or attached under a first side of the liquid crystal panel, the display driver integrated circuit may output plurality of source drive signals to the plurality of data output terminals in a reverse sequence. The plurality of source drive signals may activate the plurality of source lines. The first gate driver may include plurality of first gate driver circuits connected each to the first gate lines and the second gate driver may include a plurality of second gate driver circuits connected each to the second gate lines. The first gate driver may drive (e.g., sequentially) the first gate lines in sync with a first vertical sync start signal and the second gate driver may drive (e.g., sequentially) the second gate lines in sync with a second vertical sync start signal. The first through fourth clock signals may have the same or substantially the same frequency, while the first and second clock signals may be contrary to each other in phase. The third and fourth clock signals may be contrary to each other in phase, and the first and second clock signals may be different from the third and fourth clock signals in phase by about a ½ cycle.

At least one other example embodiment provides a display driver integrated circuit including a timing controller, a source driver and a clock generator. The timing controller may be configured to output an image data signal, a control signal and first and second selection signals. The source driver may be configured to drive a plurality of source lines in response to the image data signal and the control signal. The clock generator may be configured to output a plurality of clock signals to a plurality of terminals, for example, the clock generator may output each of the plurality of clock signals to one of the plurality of terminals based on the first and second selection signals.

According to at least some example embodiments, the clock generator may include a clock generation circuit for generating the first through fourth clock signals and a switching circuit for outputting the first through fourth clock signals in correspondence with the first through fourth terminals one by one in response to the first and second selection signals. The first through fourth clock signals may have the same or substantially the same frequency and the first and second clock signals may be contrary to each other in phase. The third and fourth clock signals may be contrary to each other in phase, and the first and second clock signals may be different from the third and fourth clock signals in phase by about a ½ cycle.

### BRIEF DESCRIPTION OF THE FIGURES

Example embodiments will be described with reference to the following figures, wherein like reference numerals refer to like parts throughout the various figures unless otherwise specified. In the figures:

FIG. 1 is a block diagram illustrating an organization of a liquid crystal display according to an example embodiment;

FIG. 2 is a block diagram illustrating a more detailed, example structure of the first and second gate drivers shown in FIG. 1;

FIGS. 3 through 6 are diagrams showing example operations of a plurality of clock signals output from a plurality of output terminals of a display driver IC according to example embodiments;

FIG. 7 is a block diagram illustrating a more detailed, example structure of a clock generator according to an example embodiment; and

FIG. 8 is a timing diagram of the first through fourth clock signals generated from the clock generator shown in FIG. 7.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

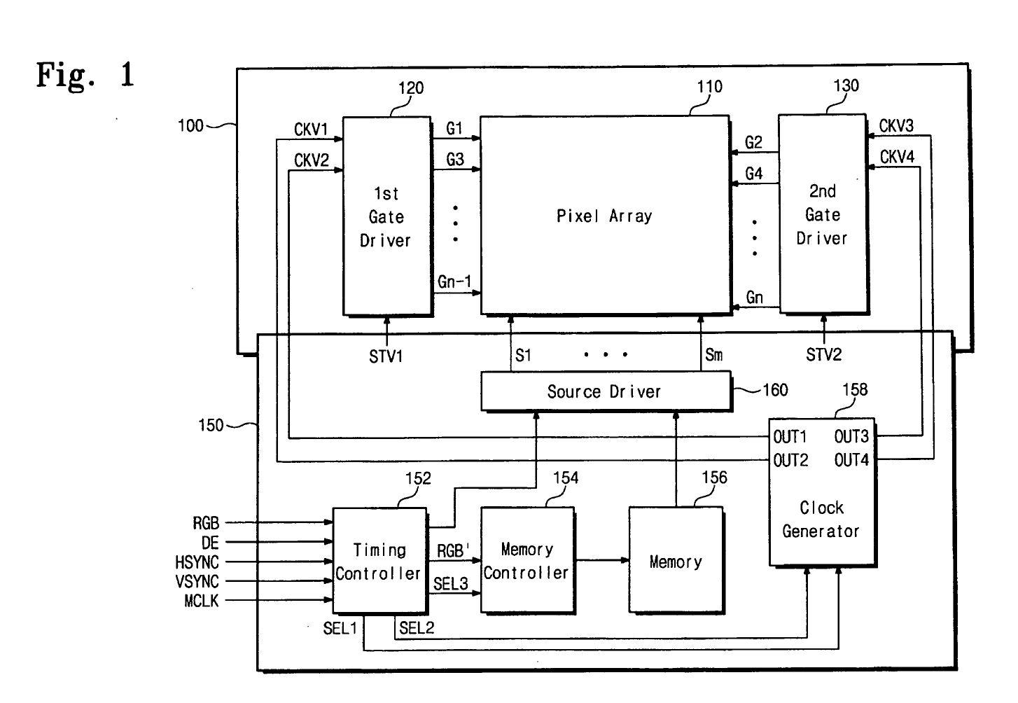

FIG. 1 is a block diagram illustrating a liquid crystal display (LCD) according to an example embodiment. Referring to FIG. 1, the LCD may include a liquid crystal panel 100 and a display driver integrated circuit (DDI) 150. The liquid crystal panel 100 may employ, for example, amorphous-silicon thin film transistors (a-Si TFTs) or the like. First and second gate drivers 120 and 130 may be formed on a glass substrate including a pixel array 110. The first and second gate drivers 120 and 130 may drive gate lines G1˜Gn.

The pixel array 110 may include a plurality of the gate lines G1˜Gn, a plurality of source lines S1˜Sm, and a plurality of pixels (not shown) formed at regions defined by intersections of the gate lines G1˜Gn and source lines S1˜Sm. Each pixel may include a switching element (not shown) connected to corresponding gate and source lines, and liquid crystal and storage capacitors (not shown) connected to the switching element.

The first gate driver 120 may be arranged at a first side of the pixel array 110. The first gate driver 120 may drive (e.g., sequentially drive) a first group of gate lines, for example, the gate lines G1, G3, . . . , Gn-1 (hereinafter, G1˜Gn-1). The first gate driver 120 may drive the first group of gate lines G1˜Gn-1 in sync with a first vertical start signal STV1 and first and second clock signals CKV1 and CKV2 provided from the DDI 150. The second gate driver 130 may be arranged at a second side of the pixel array 110. For example, the second gate driver 130 may be arranged opposite the first gate driver 120. The second gate driver 130 may drive (e.g., sequentially drive) a second group of gate lines, for example, gate lines G2, G4, . . . , Gn (hereinafter, G2˜Gn). The second group of gate lines G2˜Gn may be in sync with a second vertical start signal STV2 and third and fourth clock signals CKV3 and CKV4 provided from the DDI 150.

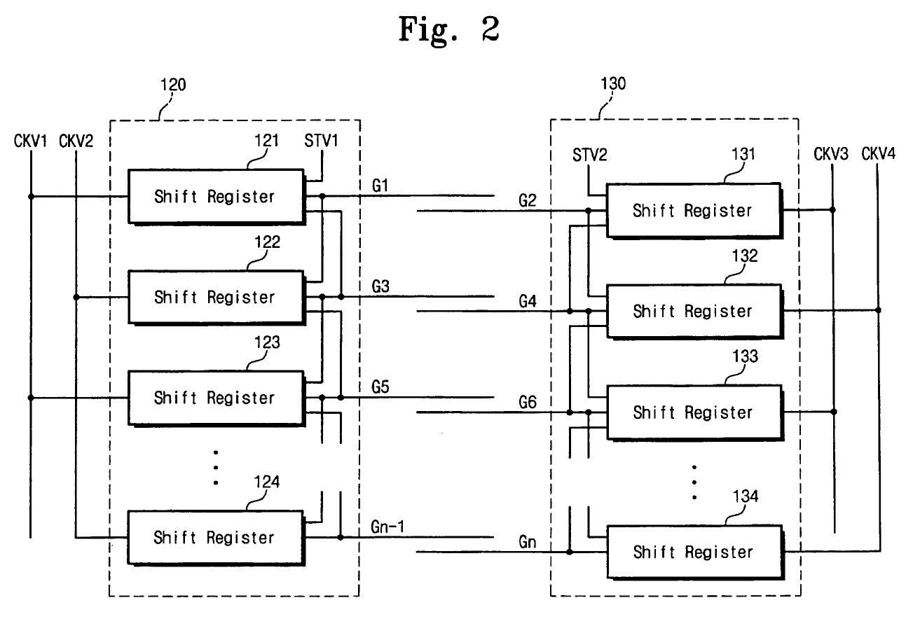

FIG. 2 is a block diagram illustrating a more detailed, example structure of the first and second gate drivers 120 and 130 shown in FIG. 1.

Referring to FIG. 2, the first gate driver 120 may include plurality of shift registers 121˜124, each corresponding to one of the gate lines G1˜Gn-1 in the first group of gate lines. If the first vertical start signal STV1 is activated, the shift register 121 may drive the gate line G1 in response to the first clock signal CKV1. By activating the gate line G1, the shift register 122 may drive the gate line G3 in response to the second clock signal CKV2. Accordingly, the gate lines G1˜Gn-1 of the first group may be activated in sequence or sequentially.

The second gate driver 130 may include plurality of shift registers 131˜134, each corresponding to one of the gate lines in the second group of the gate lines G2˜Gn. If the second vertical start signal STV2 is activated, the shift register 131 may drive the gate line G2 in response to the third clock signal CKV3. By activating the gate line G2, the shift register 132 may drive the gate line G4 in response to the fourth clock signal CKV4. Accordingly, the gate lines G2˜Gn of the second group may be activated in sequence or sequentially.

Returning to FIG. 1, the DDI 150 may be joined or attached to the liquid crystal panel 100 in a COG, COF, ACF or the like. The DDI 150 may include a timing controller 152, a memory controller 154, a memory 156 and/or a source driver 160.

The timing controller 152 may receive an image data signal RGB, a horizontal sync signal HSYNC, a vertical sync signal VSYNC and a data-enabling signal DE from an external system. The timing controller 152 may output an image data signal RGB′ and control signals for driving the liquid crystal panel 100.

The memory controller 154 may store the image data signal RGB′ in the memory 156, and output the image data signal RGB′ to the source driver 160. The memory controller 154 may determine a position of the memory 156 in which the image data signal RGB′ may be stored. The memory controller 154 may store the image data signal RGB′ according to a selection signal SEL3 output from the timing controller 152.

The memory 156 may have a size or storage capacity capable of storing the image data signals RGB′ for driving a line or frame of the pixel array 110.

The source driver 160 may drive the source lines S1˜Sm using the image data signals RGB′ from the memory 156, in response to control operation by the timing controller 152.

The clock generator 158 may generate the first through fourth clock signals CKV1˜CKV4. The clock generator 158 may apply the first through fourth clock signals CKV1˜CKV4 to the first and second gate drivers 120 and 130 in response to first and second selection signals SEL1 and SEL2 from the timing controller 152. The first through fourth clock signals CKV1˜CKV4 may be output through output terminals OUT1˜OUT4.

As illustrated in FIG. 1, the DDI 150 may be joined or attached to a top portion of a lower side or end of the liquid crystal panel 100. Based on the position at which the DDI 150 is joined or attached to the liquid crystal panel 100 (e.g., above or below, the upper or lower end), the first through fourth clock signals CKV1˜CKV4 may be output on corresponding output terminals OUT1˜OUT4 to suppress and/or prevent intersections among signal lines supplying the first through fourth clock signals CKV1˜CKV4 to the liquid crystal panel 100.

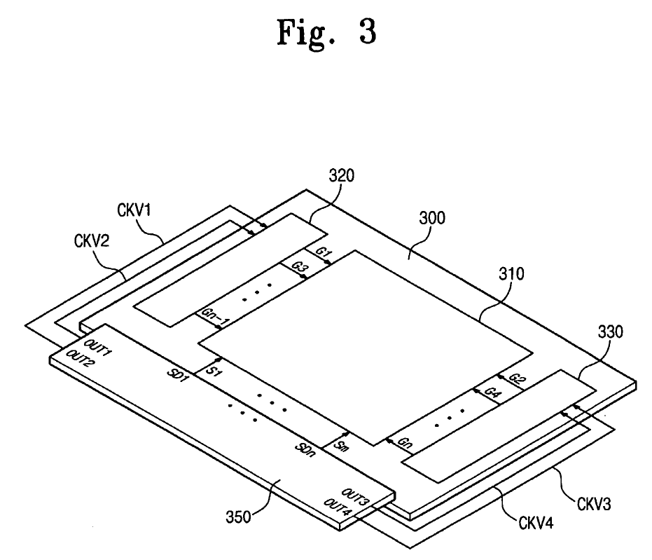

FIGS. 3 through 6 are diagrams showing example operations of the first through fourth clock signals CKV1˜CKV4 output from the first through fourth output terminals OUT1˜OUT4 of a display driver IC according to a position at which the display driver IC is joined or attached to a liquid crystal panel.

FIG. 3 shows an example case of joining a DDI 350 on a top portion of the lower side or end of a liquid crystal panel 300. Referring to FIG. 3, the first output terminal OUT1 may be disposed at the left upper end of the DDI 350 and the second output terminal OUT2 may be disposed at the lower left. The third output terminal OUT3 may be disposed at the upper right and the fourth output terminal OUT4 may be disposed at the lower right in the DDI 350. To suppress and/or prevent tangle of signal lines supplying the clock signals CKV1˜CKV4 to first and second drivers 320 and 330 of the liquid crystal panel 300, the first, second, third, and fourth output terminals, OUT1, OUT2, OUT3, and OUT4 may be arranged to output the second, first, fourth, and third clock signals, CKV2, CKV1, CKV4, CKV3, respectively. Accordingly, the first through fourth clock signals CKV1˜CKV4 may be output to the first and second drivers 320 and 330 with little or no intersection among the signal lines.

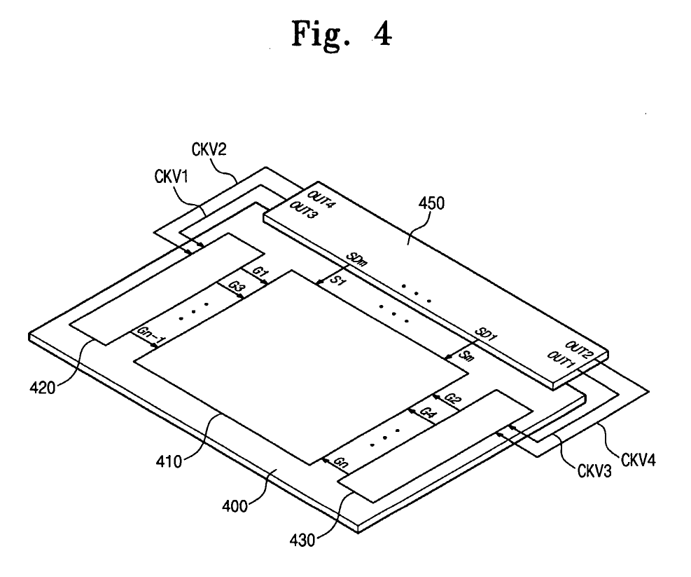

FIG. 4 shows another example case of joining a DDI 450 on a top portion of an upper side or end of a liquid crystal panel 400. Referring to FIG. 4, the first, second, third, and fourth output terminals, OUT1, OUT2, OUT3, and OUT4 of the DDI 450 may be arranged to output the third, fourth, first, and second clock signals, CKV3, CKV4, CKV1, CKV2, respectively. Accordingly, intersection among the signal lines supplying the first through fourth clock signals CKV1˜CKV4 to first and second drivers 420 and 430 of the liquid crystal panel 400 may be suppressed and/or prevented.

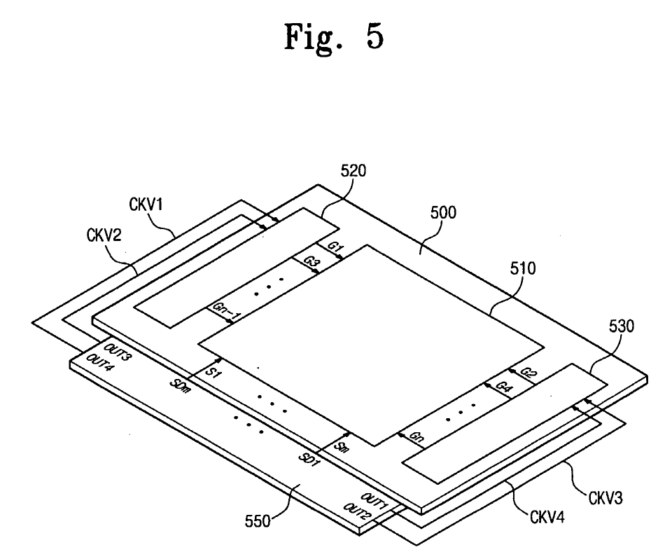

FIG. 5 shows another example case of attaching or joining a DDI 550 to a bottom portion of a lower side or end of a liquid crystal panel 500. Referring to FIG. 5, the first, second, third, and fourth output terminals, OUT1, OUT2, OUT3, and OUT4 of the DDI 550 may be arranged to output the fourth, third, second, and first clock signals, CKV4, CKV3, CKV2, CKV1, respectively. Accordingly, intersection among the signal lines supplying the first through fourth clock signals CKV1˜CKV4 to first and second drivers 520 and 530 of the liquid crystal panel 500 may be suppressed and/or prevented.

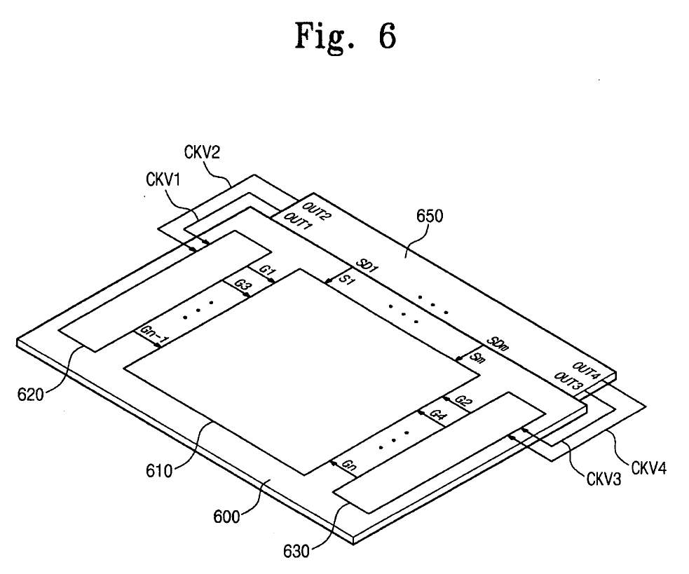

FIG. 6 shows another example case of joining or attaching a DDI 650 to a bottom portion of a lower side or end of a liquid crystal panel 600. Referring to FIG. 6, the first, second, third, and fourth output terminals, OUT1, OUT2, OUT3, and OUT4 of the DDI 650 may be arranged to output the first, second, third, and fourth clock signals, CKV1, CKV2, CKV3, CKV4, respectively. Accordingly, intersection among the signal lines supplying the first through fourth clock signals CKV1 CKV4 to first and second drivers 620 and 630 of the liquid crystal panel 600 may be suppressed and/or prevented.

As illustrated in FIGS. 3 through 6, each of the first through fourth clock signals CKV1˜CKV4 may correspond to one of the first through fourth output terminals OUT1˜OUT4 in accordance with positions at which a DDI is joined or attached to the liquid crystal panel. As a result, intersection and/or tangle among the signal lines supplying the first through fourth clock signals CKV1˜CKV4 to first and second drivers of the liquid crystal panel may be suppressed and/or prevented.

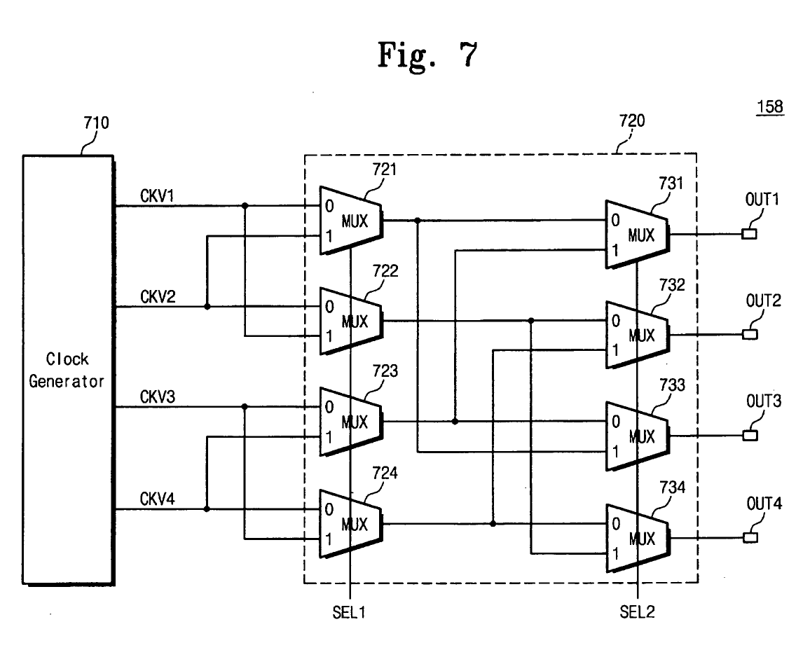

FIG. 7 is a block diagram illustrating a structure of a clock generator according to an example embodiment. The clock generator 158 in FIG. 7 may be used as the clock generator 158 shown in FIG. 1.

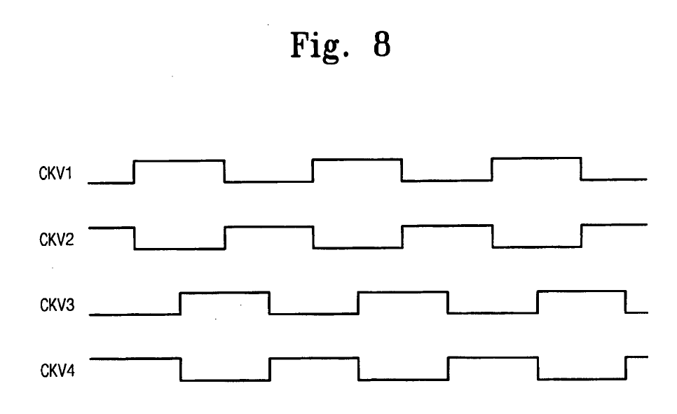

Referring to FIG. 7, the clock generator 158 may include a clock generation circuit or unit 710 and a selection circuit or unit 720. The selection circuit 720 may include a plurality of (e.g., eight) multiplexers 721˜724 and 731˜734. Example operating waveforms for the first through fourth clock signals CKV1˜CKV4 generated by the clock generation circuit 710 are illustrated in FIG. 8.

Referring to FIG. 8, the first through fourth clock signals CKV1˜CKV4 may have the same or substantially the same frequency. The first and second clock signals, CKV1 and CKV2, may have different (e.g., opposite) phases, and the third and fourth clock signals, CKV3 and CKV4, may have different (e.g., opposite) phases. The first and second clock signals, CKV1 and CKV2, may be different from the third and fourth clock signals CKV3 and CKV4 in phase by about ½ cycle.

Returning to FIG. 7, the multiplexers, 721 and 722, may receive the first and second clock signals CKV1 and CKV2; while the multiplexers, 723 and 724, may receive the third and fourth clock signals CKV3 and CKV4. The multiplexers 731 and 733 may receive outputs from the multiplexers 721 and 723. The multiplexers 732 and 734 may receive outputs from the multiplexers 722 and 724. Each of the multiplexers 721˜724 may selectively output one of input signals in response to the first selection signal SEL1 provided from the timing controller 152 shown in FIG. 1. The multiplexer 731 may selectively output one of input signals to the first output terminal OUT1 in response to the second selection signal SEL2 provided from the timing controller 152 shown in FIG. 1. The multiplexer 732 may selectively output one of input signals to the second output terminal OUT2 in response to the second selection signal SEL2. The multiplexer 733 may selectively output one of input signals to the third output terminal OUT3 in response to the second selection signal SEL2. The multiplexer 734 may selectively output one of input signals to the fourth output terminal OUT4 in response to the second selection signal SEL2.

The clock generator 158 shown in FIG. 7 may generate the first through fourth clock signals CKV1˜CKV4, and output one of the first through fourth clock signals CKV1˜CKV4 to each of the first through fourth output terminals OUT1˜OUT4, in response to the selection signals SEL1 and SEL2. Thus, each of the first through fourth clock signals CKV1˜CKV4 may be selectively output to each of the first through fourth output terminals OUT1˜OUT4 as desired.

Referring back to FIGS. 3 through 6, output positions of the source drive signals S1˜Sm may be altered in accordance with a position at which the DDI is joined or attached to the liquid crystal panel. As shown in FIG. 3, when the DDI 350 is attached to a top portion of a lower side of the liquid crystal panel 300, the source drive signals S1˜Sm may be output through the source output terminals SD1˜SDm, respectively, in a forward sequence. Similarly, as shown in FIG. 6, when the DDI 650 is attached to a bottom portion of an upper side of the liquid crystal panel 600, the source drive signals S1˜Sm may be output through the source output terminals SD1˜SDm, respectively, in a forward sequence. In each of FIGS. 3 and 6, the first source drive signal S1 may be output through the first source output terminal SD1 and the last source drive signal Sm may be output through the last source output terminal SDm.

As shown in FIG. 4, when the DDI 450 is attached to a top portion of an upper side of the liquid crystal panel 400, the source drive signals S1˜Sm may be output through the source output terminals SD1˜SDm, respectively, in a reverse sequence. Similarly, as shown in FIG. 5, when the DDI 550 is attached to a bottom portion of a lower side of the liquid crystal panel 500, the source drive signals S1˜Sm may be output through the source output terminals SD1˜SDm, respectively, in a reverse sequence. For example, in each of FIGS. 4 and 5, the first source drive signal S1 may be output through the last source output terminal SDm and the last source drive signal Sm may be output through the first source output terminal SD1.

This corresponding relation between the source drive signals S1˜Sm and the source output terminals SD1˜SDm may be arranged by the memory controller shown in FIG. 1. The memory controller 154 may store the image data signals RGB′ in the memory 156 from the timing controller 152 in a forward sequence when the third selection signal SEL3 is at a first level (e.g., a logic high or low level). The memory controller 154 may store the image data signals RGB′ in the memory 156 from the timing controller 152 in the reverse sequence when the third selection signal SEL3 is at a second level (e.g., a logic high or low level). The image data signals RGB′ stored in the memory 156 may be output to the source driver 160 in accordance with control operations by the timing controller 152 and the memory controller 154. Thus, according to a position at which the DDI is joined or attached to the liquid crystal panel, the source drive signals S1˜Sm through the source output terminals SD1˜SDm may be output in a forward or reverse sequence.

As described above, the first through fourth clock signals may correspond to the first through fourth output terminals according to a position at which the DDI is attached or joined to the liquid crystal panel. As a result, intersection and/or tangle of the signal lines supplying the first through fourth clock signals to first and second drivers of the liquid crystal panel may be suppressed and/or prevented. Accordingly, the DDI may be joined or attached to various positions of the liquid crystal panel.

The above-disclosed subject matter is to be considered illustrative, and not restrictive, and the appended claims are intended to cover all such modifications, enhancements, and other example embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A display driver comprising:
a display driver integrated circuit configured to determine a correspondence between a plurality of clock signals and a plurality of terminals based on a position at which the display driver is attached to a liquid crystal panel, the display driver integrated circuit being further configured to output the plurality of clock signals to the liquid crystal panel through the plurality of terminals based on the determined correspondence.

2. A liquid crystal display comprising:
the display driver as set forth in claim 1, and
a liquid crystal panel to which the display driver is attached, the liquid crystal panel including,
an array of pixels arranged at intersections of a plurality of gate lines and a plurality of source lines, and
a first gate driver connected to at least a portion of the plurality of gate lines, the first gate driver being configured to operate at least a portion of the plurality of gate lines based on at least a portion of the plurality of clock signals.

3. The liquid crystal display as set forth in claim 2, wherein the first gate driver is connected to each of the plurality of gate lines, and the first gate driver is configured to operate the plurality of gate lines based on the plurality of clock signals,

4. The liquid crystal display as set forth in claim 3, wherein the display driver is attached to the liquid crystal panel by way of chip-on-glass.

5. The liquid crystal display as set forth in claim 3, wherein the first gate driver includes, a plurality of first gate driver circuits, each of the plurality of first gate driver circuits corresponding to one of the plurality of gate lines.

6. The liquid crystal display as set forth in claim 3, wherein the first gate driver sequentially drives the plurality of gate lines in response to a vertical sync start signal.

7. The liquid crystal display as set forth in claim 3, wherein the display driver integrated circuit includes,
a clock generator configured to generate the plurality of clock signals, and
a switching circuit configured to output each of the plurality of clock signals to one of the plurality of terminals based on at least one selection signal.

8. The liquid crystal display as set forth in claim 2, wherein the first gate driver is connected to a first group of the plurality of gate lines, the first gate driver being configured to operate the first group of the plurality of gate lines based on a first and a second of the plurality of clock signals, the liquid crystal display further including,
a second gate driver connected to a second group of the plurality of gate lines, the second gate driver being configured to operate the second group of the plurality of gate lines based on a third and a fourth of the plurality of clock signals.

9. The liquid crystal display as set forth in claim 8, wherein the display driver integrated circuit includes,
a clock generator configured to generate the plurality of clock signals, and
a switching circuit configured to output each of the plurality of clock signals to one of the plurality of terminals based on at least one selection signal.

10. The liquid crystal display as set forth in claim 9, wherein the switching circuit outputs each of the plurality of clock signals to a corresponding one of the plurality of terminals based on an attachment position of the display driver to the liquid crystal panel.

11. The liquid crystal display as set forth in claim 10, wherein if the display driver is attached to a top portion of a lower side of the liquid crystal panel, the switching circuit outputs the first and second clock signals to a second and first of the plurality of terminals, respectively, and outputs the third and fourth clock signals to a fourth and third of the plurality of terminals, respectively.

12. The liquid crystal display as set forth in claim 10, wherein if the display driver is attached to a top portion of an upper side of the liquid crystal panel, the switching circuit outputs the first and second clock signals to a third and a fourth of the plurality of terminals, respectively, and outputs the third and fourth clock signals to a first and a second of the plurality of terminals, respectively.

13. The liquid crystal display as set forth in claim 10, wherein if the display driver is attached to a bottom portion of a lower side of the liquid crystal panel, the switching circuit outputs the first and second clock signals to a fourth and third of the plurality of terminals, respectively, and outputs the third and fourth clock signals to a second and first of the plurality of terminals, respectively.

14. The liquid crystal display as set forth in claim 10, wherein if the display driver is attached to a bottom portion of an upper side of the liquid crystal panel, the switching circuit outputs the first and second clock signals to a first and a second of the plurality of terminals, respectively, and outputs the third and fourth clock signals to a third and a fourth of the plurality of terminals, respectively.

15. The liquid crystal display as set forth in claim 8, wherein the display driver integrated circuit is further configured to output a plurality of source drive signals to the liquid crystal panel for activating the plurality of source lines, the plurality of source drive signals being output through a plurality of data output terminals.

16. The liquid crystal display as set forth in claim 15, wherein the display driver integrated circuit outputs the plurality of source drive signals to the plurality of data output terminals in a forward or reverse sequence based on a side of the liquid crystal panel to which the display driver is attached.

17. The liquid crystal display as set forth in claim 16, wherein the plurality of source drive signals are output to the plurality of data output terminals in a reverse sequence if the display driver is attached to a bottom portion of a lower side or a top portion of an upper side of the liquid crystal panel.

18. The liquid crystal display as set forth in claim 16, wherein the plurality of source drive signals are output to the plurality of data output terminals in a forward sequence if the display driver is attached to a top portion of a lower side or a bottom portion of an upper side of the liquid crystal panel.

19. The liquid crystal display as set forth in claim 10, wherein the first gate driver includes a plurality of first gate driver circuits, each of the plurality of first gate driver circuits being connected to a gate line in the first group of the plurality of gate lines, and the second gate driver includes a plurality of second gate driver circuits, each of the plurality of second gate driver circuits being connected a gate line in the second group of the plurality of gate lines.

20. The liquid crystal display as set forth in claim 19, wherein the first gate driver sequentially drives the gate lines in the first group of the plurality of gate lines in sync with a first vertical sync start signal, and the second gate driver sequentially drives the gate lines in the second group of the plurality of gate lines in sync with a second vertical sync start signal.

21. The liquid crystal display as set forth in claim 10, wherein the display driver is attached to the liquid crystal panel by way of chip-on-glass.

22. The liquid crystal display as set forth in claim 10, wherein the plurality of clock signals includes first through fourth clock signals, each of the first through fourth clock signals having the same frequency, the first and second clock signal having different phases, the third and fourth clock signals having different phases, and the first and second clock signals being different from the third and fourth clock signals in phase by ½ cycle.

23. The display driver as set forth in claim 1, wherein the display driver integrated circuit includes,
a timing controller configured to output an image data signal, a control signal and a plurality of selection signals,
a source driver configured to drive a plurality of source lines in response to the image data signal and the control signal, and
a clock generator configured to output each of a plurality of clock signals to one of a plurality of terminals based on the plurality of selection signals.

24. The display driver as set forth in claim 23, wherein the clock generator includes,
a clock generation circuit configured to generate the plurality of clock signals, and
a switching circuit configured to output the plurality of clock signals to the plurality of terminals based on the plurality of selection signals.

25. The display driver as set forth in claim 23, wherein the plurality of clock signals includes first through fourth clock signals, each of the first through fourth clock signals having the same frequency, the first and second clock signal having different phases, the third and fourth clock signals having different phases, and the first and second clock signals being different from the third and fourth clock signals in phase by ½ cycle.
